(19) United States
(12) Patent Application Publication
(10) Pub. No.: US 2025/0192964 A1
(43) Pub. Date: Jun. 12, 2025

(54) SYSTEMS AND METHODS FOR SUPPORTING MULTI-LAYER TRANSMISSION IN A WIRELESS NETWORK

(71) Applicant: Huawei Technologies Co., Ltd., Shenzhen (CN)

(72) Inventors: Xi Zhang, Beijing (CN); Wen Tong, Ottawa (CA); Xiaoyan Bi, Shanghai (CN); Jianglei Ma, Ottawa (CA)

(21) Appl. No.: 19/060,179

(22) Filed: Feb. 21, 2025

Related U.S. Application Data
(63) Continuation of application No. PCT/CN2022/118079, filed on Sep. 9, 2022.

(51) Int. Cl. H04L 5/00; H04B 7/06; H04W 74/0833

(52) U.S. Cl. CPC H04L 5/0057; H04B 7/0626; H04W 74/0833

(57) ABSTRACT

Aspects of the present disclosure provide systems and methods for supporting multi-layer data transmission. An apparatus (e.g. user equipment), upon request of a network device (e.g. base station), may generate a channel state information (CSI) report based on measurement of synchronization signal-physical broadcast channel (SS-PBCH) blocks (SSBs) transmitted over multiple antenna ports. The CSI report may include information related to apparatus-specific CSI and/or information indicative of quality of sub-channels. The network device may transmit configuration information related to the CSI report, measurement configuration of the SSBs, and/or configurations for supporting early MIMO transmission.

### CROSS REFERENCE

This application is a continuation of International Application No. PCT/CN2022/118079, filed on Sep. 9, 2022, the disclosure of which is hereby incorporated by reference in its entirety.

### TECHNICAL FIELD

The present disclosure relates generally to wireless communications, and in particular to systems and methods for supporting multi-layer data transmission in a wireless communication system.

### BACKGROUND

In Fifth Generation (5G) New Radio (NR), a synchronization signal-physical broadcast channel (SS-PBCH) block (SSB) is transmitted with one antenna port, i.e. antenna port p=4000 is used for transmission of primary synchronization signal (PSS), secondary synchronization signal (SSS), physical broadcast channel (PBCH) and demodulation reference signal (DM-RS) for PBCH. An antenna port is a virtual concept and is not necessarily equivalent to transmission on a given antenna. For example, a base station (BS) may use two antennas to transmit one antenna port. A user equipment (UE) may have no knowledge of antenna architecture at the base station or how such 1-port SSB is transmitted via one or more antennas at the base station.

At frequencies in the millimeter wave (mmWave) range (e.g., 26, 38, 39, 73 GHz) and the mid-band range (e.g., 3.5, 3.7, 4.7, 4.9 GHz), dual-polarized antennas are widely used at the base station and the UE. With dual-polarized antennas, two linearly polarized antennas are often superposed on a same location, but separated by about 90 degrees in polarization direction, for example, vertical and horizontal polarization directions or ±45 degree slant polarization directions. With dual-polarized antennas, independent signals can be transmitted from antennas with different polarization directions. There may be multiple antennas corresponding to the same polarization direction, for example, the first and second groups of antennas for vertical and horizontal polarization directions or ±45 degree slant polarization directions, respectively. In this case, one antenna over vertical or −45-degree slant polarization direction may be superposed with one antenna over horizontal or ±45-degree slant polarization direction. It is also possible that the first and second groups of antennas for vertical and horizontal polarization directions or ±45 degree slant polarization directions are located separately, e.g., the first group of antennas at one location and the second group of antennas at another location. In such cases, the number of antennas in the first and the second groups of antennas can be same or different.

With 1-port SSB and dual-polarized antennas, typically the base station transmits a same SSB signal via dual-polarized antennas, and the UE also measures with dual-polarized antennas. In 5G NR, it is expected that a measured result should not be less than the result based on measurement from either of the dual-polarized antennas at the apparatus when considered individually, or no less than the result based on measurement from the polarized antennas at the apparatus over either polarization direction. The measured signals from the dual-polarized antennas at the UE may be compared or combined, and a decision of the exact manner of processing is left to the UE (e.g., maximum power, average power). As the same SSB signal is transmitted via dual-polarized antennas at the base station, the UE may not be able to tell which polarized antenna(s) of the base station or polarized antennas over which polarization direction the received signal is from. The base station may select one or multiple antennas over one polarization direction to transmit an SSB, but such selection is unknown to the UE.

In existing wireless communication systems, that may include 4G long-term evolution (LTE), and 5G NR, data transmission such as multi-input multi-output (MIMO) transmission may be enabled only after radio resource control (RRC) connection is established. As illustrated in FIG. 1, which illustrates a signal flow diagram between a base station (BS) 10 and a UE 15, signals and channels such as SSB, physical random access channel (PRACH), physical downlink control channel (PDCCH), physical downlink shared channel (PDSCH) carrying system information (SI) or random access response (RAR) or RRC connection setup message, and/or physical uplink shared channel (PUSCH) carrying Msg3 are transmitted using 1 antenna port or with 1 layer.

In existing wireless communication systems, the base station 10 may configure a UE 15 to measure multi-port channel state information reference signal (CSI-RS) and report channel state information (CSI) after RRC connection is established. MIMO transmissions (e.g., 2-layer transmission) may be enabled after the CSI is reported, for example at step 25, to the base station 10. As a result, in the existing wireless communication systems there may be a large latency 20 between detecting a first SSB by a UE 15, and MIMO transmission for the UE 15 in the RRC connected mode at step 29, as illustrated in FIG. 1.

### SUMMARY

As noted above, in existing wireless communication systems (e.g. 4G LTE, 5G NR), there may be a large latency between SSB detection in the initial access procedure and MIMO data transmission in the RRC connected mode. An apparatus (e.g. user equipment (UE)) is unable to transmit a CSI report using a PUSCH scheduled by RAR uplink grant in a non-contention-based random access procedure, because the apparatus may not have knowledge of whether a multi-port reference signal (RS) exists or know how a multi-port RS is configured until RRC connection is established. When a network device (e.g. base station) is deployed with dual-polarized antennas, when using existing measurement and reporting techniques, the network device may be unaware of the quality of polarized sub-channels (e.g., over vertical and horizontal polarization directions, over ±45 degree slant polarization directions), the isolation or interference between polarized sub-channels, or both.

Aspects of the present disclosure provide methods and devices to overcome the shortcomings described above, as well as specific methods for enabling MIMO transmission or multi-layer transmission at an earlier point in time. In some embodiments, the earlier point in time may be immediately after an initial access procedure. In some embodiments, the earlier point in time may be during an initial access procedure. Aspects of the present disclosure also provide methods and devices to reduce large latency between initial access and MIMO transmission.

According to an aspect of the disclosure there is provided a method for supporting data transmission in a wireless network involving receiving a request for a channel state information (CSI) report associated with one or more synchronization signal-physical broadcast channel (SS-PBCH) blocks (SSBs), where the one or more SSBs are transmitted over 2 antenna ports. The method may further include transmitting a response to the request for the CSI report on a physical uplink shared channel (PUSCH) or a physical uplink control channel (PUCCH), where the response includes at least one of: an indication of whether the CSI report is included in the response, or the CSI report based on measurement of the one or more SSBs transmitted over the 2 antenna ports.

In some embodiments, when receiving the request for the CSI report occurs on a random access response (RAR), the method may further include transmitting a physical random access channel (PRACH) before receiving the RAR as a response. In some embodiments, the one or more SSBs transmitted over the 2 antenna ports may be received before the PRACH transmission. In some embodiments, the one or more SSBs transmitted over the 2 antenna ports associated with the PRACH transmission may be received within a time period between the PRACH transmission and reception of the request for the CSI report.

In some embodiments, the CSI report may include at least one of: SSB resource indicator (SSBRI), reference signal received power (RSRP), signal-to-interference plus noise ratio (SINR), rank indicator (RI), channel quality indicator (CQI), precoding matrix indicator (PMI), per-SSB-port signal-to-interference plus noise ratio (SINR) or per-SSB-port CQI where each SINR or CQI is associated with a respective SSB port, or per-PMI SINR or per-PMI CQI where each SINR or CQI is associated with a respective PMI. In some embodiments, when the CSI report includes the RI indicating the maximum rank, after transmitting the CSI report, the apparatus may behave based on an assumption that the maximum number of layers for physical downlink share channel (PDSCH) is equal to the reported maximum rank or the smallest integer 2″ that is less than or equal to the reported maximum rank where n=0, 1, 2, 3, . . . . In some embodiments, for each per-SSB-port SINR or per-SSB-port CQI, the per-SSB-port SINR or the per-SSB-port CQI may be determined based on a respective SSB port and one or more remaining SSB ports of the same SSB, where the one or more remaining SSB ports are considered as interference during determination of the per-SSB-port SINR or the per-SSB-port CQI.

In some embodiments, the CSI report may be transmitted from the Message-3 PUSCH during random access (RA).

In some embodiments, the method may further include receiving one or more signals indicative of system information in a master information block (MIB), a secondary information block (SIB), or both. In some embodiments, the one or more signals may include one or more of: information related to at least one of measurement configuration or report configuration for the CSI report based on the one or more SSBs transmitted over the 2 antenna ports, information indicative of whether the CSI report is to be transmitted via the Message-3 PUSCH, information indicative of whether the CSI report is to be transmitted via the PUCCH, and information related to demodulation reference signal (DMRS) configuration supporting multi-layer PDSCH transmission after transmitting the CSI report. In some embodiments, the information related to the at least one of measurement configuration or report configuration for the CSI report may include at least one of: information indicative of whether one or more SSBRIs are to be reported, information indicative of the number of the one or more SSBRIs to be reported, information indicative of which one or more parameters among SSBRI, RSRP, SINR, RI, CQI, PMI, per-SSB-port SINR or CQI, per-PMI SINR or CQI are to be reported, or information indicative of whether the CSI report is restricted to a SSB associated with PRACH transmission.

In some embodiments, the one or more SSBs transmitted over the 2 antenna ports may include one or more of: one or more primary synchronization signals (PSSs), one or more secondary synchronization signals (SSSs), a physical broadcast channel (PBCH), and one or more DMRSs for PBCH.

In some embodiments, the apparatus is a user equipment (UE). However, it should be noted that the apparatus may be other type of device such as but not limited to an access point (AP), and a transmit receive point (TRP).

According to an aspect of the disclosure there is provided an apparatus supporting data transmission in a wireless network including a processor and a computer-readable medium. The computer-readable medium has stored thereon computer executable instructions that when executed cause the processor to perform a method consistent with the embodiment described above. Examples of different types of the apparatus include but not limited to a user equipment (UE), a base station (BS), an access point (AP), and a transmit receive point (TRP).

According to an aspect of the disclosure there is provided a method involving transmitting a request for a channel state information (CSI) report associated with one or more synchronization signal-physical broadcast channel (SS-PBCH) blocks (SSBs), wherein the one or more SSBs are transmitted over 2 antenna ports. The method may further include receiving a response to the request for the CSI report on a physical uplink shared channel (PUSCH) or a physical uplink control channel (PUCCH), where the response includes at least one of: an indication of whether the CSI report is included in the response; or the CSI report based on measurement of the one or more SSBs transmitted over the 2 antenna ports.

In some embodiments, when transmitting the request for the CSI report on a random access response (RAR), the method may further include receiving a physical random access channel (PRACH) before transmitting the RAR. In some embodiments, the one or more SSBs transmitted over the 2 antenna ports may be transmitted before the PRACH reception. In some embodiments, the one or more SSBs transmitted over the 2 antenna ports associated with the PRACH transmission may be transmitted within a time period between the PRACH reception and transmission of the request for the CSI report.

In some embodiments, the CSI report may include at least one of: SSB resource indicator (SSBRI), reference signal received power (RSRP), signal-to-interference plus noise ratio (SINR), rank indicator (RI), channel quality indicator (CQI), precoding matrix indicator (PMI), per-SSB-port signal-to-interference plus noise ratio (SINR) or per-SSB-port CQI where each SINR or CQI is associated with a respective SSB port, or per-PMI SINR or per-PMI CQI where each SINR or CQI is associated with a respective PMI. In some embodiments, when the CSI report includes the RI indicating the maximum rank, after receiving the CSI report, the network device may behave based on an assumption that the maximum number of layers for physical downlink share channel (PDSCH) is equal to the reported maximum rank or the smallest integer 2n that is that is less than or equal to the reported maximum rank where n=0, 1, 2, 3, . . . . In some embodiments, for each per-SSB-port SINR or per-SSB-port CQI, the per-SSB-port SINR or the per-SSB-port CQI may be determined based on the respective SSB port and one or more remaining SSB ports of the same SSB, where the one or more remaining SSB ports are considered as interference during determination of the per-SSB-port SINR or the per-SSB-port CQI.

In some embodiments, the network device may receive the CSI report from the Message-3 PUSCH during random access (RA).

In some embodiments, the method may further include transmitting one or more signals indicative of system information in a master information block (MIB), a secondary information block (SIB), or both. In some embodiments, wherein the one or more signals may include one or more of: information related to at least one of measurement configuration or report configuration for the CSI report based on the one or more SSBs transmitted over the 2 antenna ports, information indicative of whether the CSI report is to be transmitted via the Message-3 PUSCH, information indicative of whether the CSI report is to be transmitted via the PUCCH, and information related to demodulation reference signal (DMRS) configuration supporting multi-layer PDSCH transmission after transmitting the CSI report. In some embodiments, the information related to the at least one of measurement configuration or report configuration for the CSI report may include at least one of: information indicative of whether one or more SSBRIs are to be reported, information indicative of the number of the one or more SSBRIs to be reported, information indicative of which one or more parameters among SSBRI, RSRP, SINR, RI, CQI, PMI, per-SSB-port SINR or CQI, per-PMI SINR or CQI are to be reported, or information indicative of whether the CSI report is restricted to a SSB associated with PRACH transmission.

In some embodiments, the one or more SSBs transmitted over the 2 antenna ports comprise one or more of: one or more primary synchronization signals (PSSs), one or more secondary synchronization signals (SSSs), a physical broadcast channel (PBCH), and one or more DMRSs for PBCH.

In some embodiments, the network device is a base station. However, it should be noted that the network device may be other type of device such as but not limited to an access point (AP), a transmit receive point (TRP) and a user equipment (UE).

According to an aspect of the disclosure there is provided a network device supporting data transmission in a wireless network including a processor and a computer-readable medium. The computer-readable medium has stored thereon computer executable instructions that when executed cause the processor to perform a method consistent with the embodiment described above. Examples of different types of the network device include but not limited to a base station (BS), an access point (AP), a transmit receive point (TRP) and a user equipment (UE).

In some embodiments of the present disclosure, MIMO transmissions or multi-layer PDSCH transmissions (e.g. 2-layer PDSCH transmissions) for single user and multiple users may be enabled at an earlier point in time, for example during or immediately after an initial access procedure. In some embodiments of the present disclosure, an apparatus (e.g. UE) may perform instantaneous broadband transmission with doubled capacity. In some embodiments of the present disclosure, multi-user multiplexing and cell capacity during the initial access procedure may be improved.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates an example of why large latency may occur between initial access and multi-input multi-output (MIMO) transmission in existing wireless communication systems.

FIG. 2A is a schematic diagram of a communication system in which embodiments of the present disclosure may occur.

FIG. 2B is another schematic diagram of a communication system in which embodiments of the present disclosure may occur.

FIG. 3 is a block diagram illustrating units or modules in a device in which embodiments of the present disclosure may occur.

FIG. 4 is a block diagram illustrating units or modules in a device in which embodiments of the present disclosure may occur.

FIG. 5 is a schematic diagram illustrating transmission and reception of a 1-port SSB with dual-polarized antennas.

FIG. 6 is a schematic diagram illustrating transmission of 2-port SSB with dual-polarized antennas.

FIG. 7 is a schematic diagram illustrating a network device that is unaware of quality of and/or isolation between polarized sub-channels measured at the UE.

FIG. 8 illustrates an example of a signal flow diagram between a network device and an apparatus, such as a UE, that enables reduced latency between SSB detection and MIMO transmission using a CSI report transmitted over PUSCH, such as a Msg3 PUSCH, in accordance with embodiments of the present disclosure.

FIG. 9 illustrates an example of a CSI report transmitted from an apparatus to a network device over PUSCH, the CSI report including at least one of a rank indicator (RI) or a channel quality indicator (CQI), in accordance with embodiments of the present disclosure.

FIG. 10 illustrates an example of a CSI report transmitted from an apparatus to a network device over PUSCH, the CSI report including per-SSB-port signal-to-interference plus noise ratio (SINR) in accordance with embodiments of the present disclosure.

FIG. 11 illustrates an example of a signal flow diagram for transmission of configuration information related to the CSI report and/or demodulation reference signal (DMRS), in accordance with embodiments of the present disclosure.

FIG. 12 illustrates an example of how a CSI report may be determined for SSB that are different from SSB associated with PRACH transmission, in accordance with embodiments of the present disclosure.

FIG. 13 illustrates an example of inter-apparatus polarization-based multiplexing for multiple UEs using the same beam transmitted from a network device, in accordance with embodiments of the present disclosure.

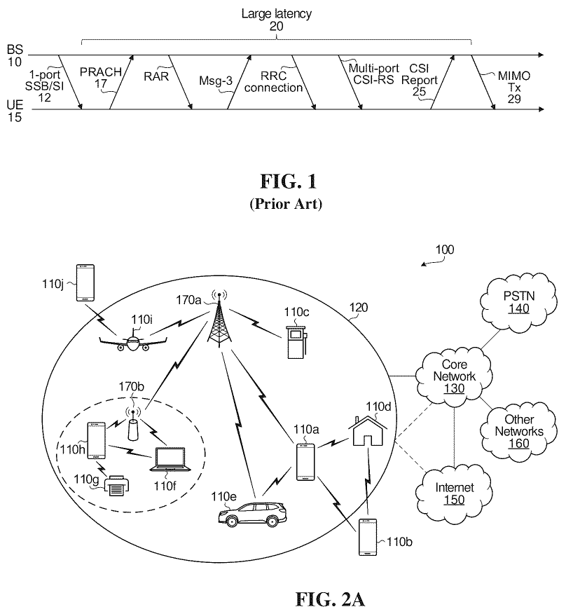

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure exploit dual-polarized antennas at a network device (e.g. base station) and an apparatus (e.g. UE) to enable MIMO data transmission during or immediately after an initial access procedure. In some embodiments, the apparatus may receive a request for a channel state information (CSI) report. The request for the CSI report may be transmitted in a random access response (RAR). The CSI report may be generated based on measurement of one or more synchronization signal-physical broadcast channel (SS-PBCH) blocks (SSBs) transmitted over 2 antenna ports. The one or more SSBs transmitted over the 2 antenna ports may be referred to as one or more 2-port SSBs in the present disclosure. The CSI report may be transmitted to the network device on a physical uplink shared channel (PUSCH), for example using Msg3 PUSCH, or a physical uplink control channel (PUCCH).

In some embodiments, the one or more 2-port SSBs may be transmitted from dual-polarized antennas of the network device (e.g. base station). In some cases, each port of a 2-port SSB may be transmitted via antenna(s) of the network device over one polarization direction (e.g., −45 or +45 degree slant polarization direction) or over one polarization direction in relation to a reference plane, for example vertical or horizontal polarization direction relative to the surface of the earth.

In some embodiments, the CSI report pertaining to the one or more SSBs transmitted over the 2 antenna ports (i.e. CSI report pertaining to the 2-port SSBs) may include information related to apparatus-specific CSI or information indicative of quality of sub-channels, or both. The information related to apparatus-specific CSI may include at least one of a rank indicator (RI), a channel quality indicator (CQI), or a precoding matrix indicator (PMI), which are used mainly for single-user MIMO transmissions for the specific apparatus. The information indicative of quality of sub-channels may include per-SSB-port signal-to-interference plus noise ratio (SINR), per-SSB-port CQI, per-PMI SINR, or per-PMI CQI. The per-SSB-port SINR, per-SSB-port CQI, per-PMI SINR or per-PMI CQI may reflect quality of sub-channels or isolation between sub-channels (e.g. sub-channels over vertical polarization direction and horizontal polarization direction), or both, to enable intra-apparatus multiplexing or inter-apparatus multiplexing, or both, of same or different signals/channels. The sub-channels may be measured at the specific apparatus to determine the quality of sub-channels or isolation between sub-channels. In some cases, said specific apparatus may be a UE. In some cases, the information indicative of quality of sub-channels may also be considered as one type or part of CSI.

Aspects of the present disclosure include signaling for facilitating or exploiting the CSI report pertaining to the one or more SSBs transmitted over 2 antenna ports (i.e. 2-port SSBs). The signaling may include broadcast signaling indicative of whether or not an apparatus is expected to determine or calculate the CSI based on measurement of the one or more SSBs transmitted over 2 antenna ports (i.e. 2-port SSBs). The broadcast signaling, additionally or alternatively, may be indicative of whether or not the apparatus may report CSI associated with one or more SSB that are different from the SSB associated with PRACH transmission. The broadcast signaling, additionally or alternatively, may be indicative of whether beam measurement is restricted to the one SSB associated with PRACH transmission. This information may be particularly relevant or useful when an apparatus moves during the initial access procedure. This information may also be particularly relevant or useful when the quality of newly measured SSB(s) is better than the quality of the SSB(s) associated with the PRACH transmission.

While the phrase “initial access” is used above and subsequently below, it should be understood that “initial access” may be replaced with “contention-based random access” or “contention-free random access”.

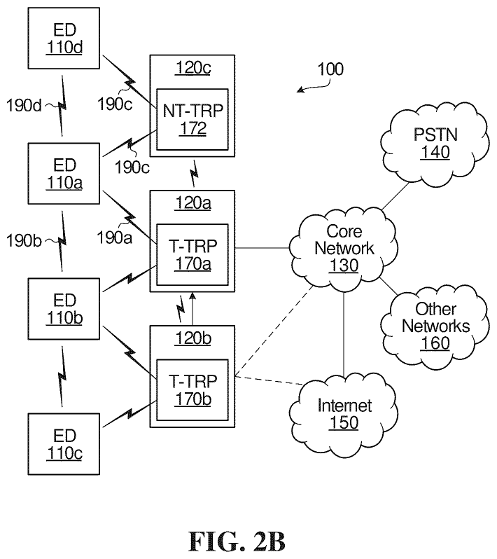

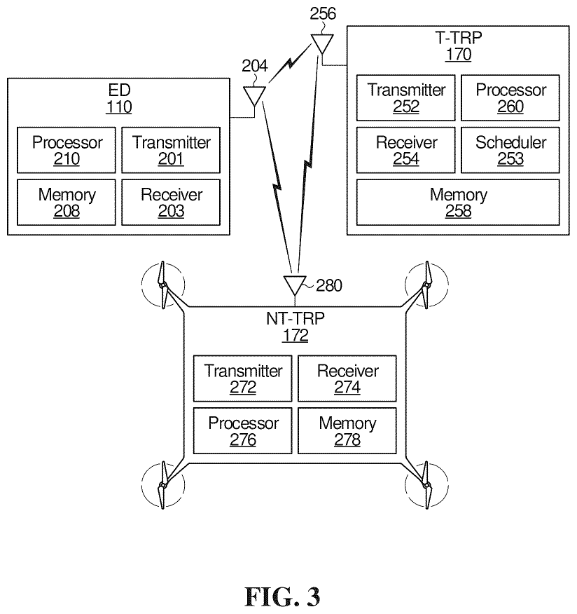

FIGS. 2A, 2B, and 3 following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1X, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIGS. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

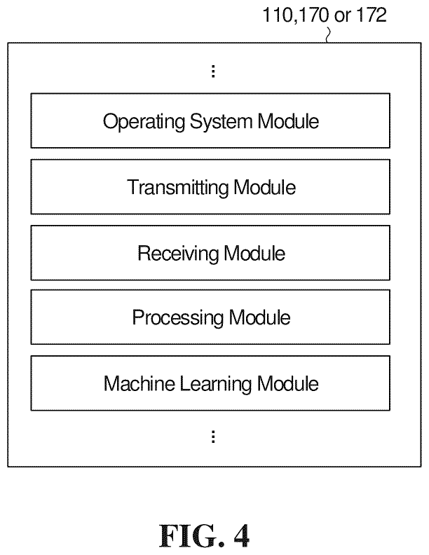

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. A new protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g. uplink control information (UCI) sent in a PUCCH or PUSCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH or PUSCH.

In existing wireless communication systems (e.g. 4G LTE, 5G NR), a grant for uplink (UL) transmission carried in the RAR includes a 1-bit field for CSI request.

In 4G LTE, this 1-bit CSI request field may be used in a non-contention-based random access procedure (e.g. radio resource control (RRC) connection is already established for a UE and the UE uses only the random access preamble assigned to the UE itself) to request CSI so that a CSI report can be received from a UE via a PUSCH scheduled by a RAR UL grant. In a contention-based random access procedure (e.g. RRC connection is not established for the UE; initial access procedure), this 1-bit CSI request field may be reserved and not used. In 5G NR, this CSI request field is inherited from the 4G LTE, but is reserved in various versions of the 5G NR standards up to Release 17.

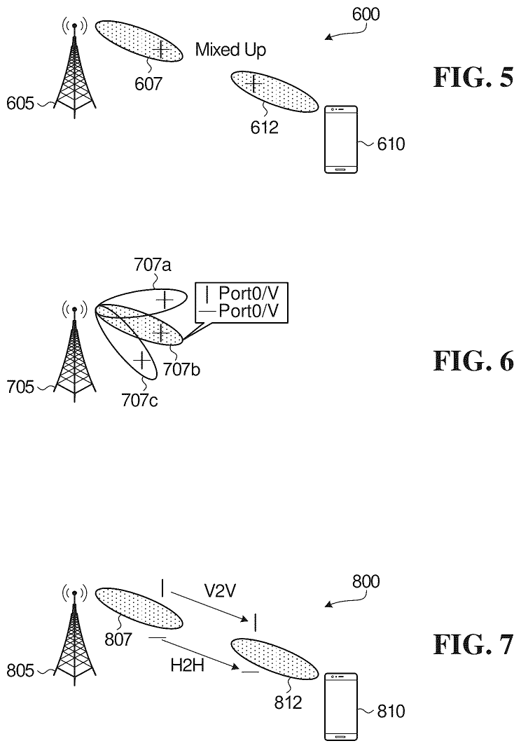

In 5G NR, SSB is transmitted with one antenna port, and in RRC connected mode, reference signal received power (RSRP) is used for beam measurement and reporting (e.g. CSI reporting). An apparatus (e.g. UE) has no knowledge about antenna polarization at the network device (e.g. base station (BS)). For example, a UE is unaware of whether the base station transmits and receives the signal using left-handed or right-handed circularly polarized antennas, linearly polarized antennas, or dual-polarized antennas. Having dual-polarized antennas at the apparatus and the network device, the network device typically transmits a same SSB signal via dual-polarized antennas, and the apparatus also measures with dual-polarized antennas. FIG. 5 illustrates a portion of a network 600 that includes a base station 605 and a UE 610. A single base station beam 607 and a single UE beam 612 that are only one beam of a number of beams that could be used at each device are shown as an example. These beams 607, 612 may be a beam pair that has been previously measured, reported, and/or selected as a preferred beam pair for communication between the devices at the time. The base station beam 607 and UE beam 612 are each shown to include two polarization directions, i.e. horizontal polarization direction and vertical polarization direction, which are indicated by the overlapping horizontal and vertical lines in the “+” symbol. At millimeter wave (mmWave) frequencies, an apparatus (e.g. UE) measures using its dual-polarized antennas under same receiving beamforming weights. The beam measurement result reported by the apparatus is expected to be no less than the result based on measurement from either of the dual-polarized antennas at the apparatus when considered individually, or no less than the result based on measurement from the polarized antennas at the apparatus over either polarization direction. The exact processing for measuring (e.g., maximum power, average power) is determined by the apparatus. The transmissions and receptions of 1-port SSB with dual-polarized antennas are illustrated in FIG. 5. Moreover, in RRC connected mode, an apparatus may perform RSRP measurement based on 2-port channel state information reference signal (CSI-RS). The RSRP value reported to the network device (e.g. base station) is an average of RSRP values measured from the 2 CSI-RS ports.

In a co-pending application (Assignee Reference 92019493PCT01), the Assignee of both that application and the present application described a method of implementing 2-port SSB to exploit dual-polarized antennas for reducing latency and/or overhead for beam-based initial access, especially for mmWave frequency bands. With such a 2-port SSB, each SSB-port is transmitted via base station antennas over one polarization direction (e.g., −45 or +45 degree slant polarization direction) or over one polarization direction in relation to a reference plane, for example vertical or horizontal polarization direction relative to the surface of the earth.

FIG. 6 illustrates a base station 705. Three base station beams 707a, 707b and 707c are shown. Each of the base station beams 707a, 707b and 707c are shown to include two polarization directions indicated by the overlapping horizontal and vertical lines that are represented by the “+” symbol. In order to reduce latency and/or overhead, one or more SSBs transmitted over 2 antenna ports (i.e. one or more 2-port SSBs) may be used in the initial access procedure. As illustrated in FIG. 6, each SSB-port of a 2-port SSB corresponds to base station antennas over one polarization direction (e.g. −45 or +45 degree slant polarization direction) or one polarization direction in relation to a reference plane or direction (e.g. vertical/horizontal polarization direction relative to the surface of the earth, ±45 degree slant polarization directions relative to a ray leaving the earth). The apparatus (e.g. UE) may map its own dual-polarized antennas to dual-polarized antennas of the network device (e.g. base station). With such mapping and association, the apparatus may be able to reduce the time needed for the initial access procedure by performing parallel beam training over dual-polarized antennas or dual polarization directions.

As stated above, there are limitations in existing wireless communication systems when enabling MIMO data transmissions. The limitations include large latency between SSB detection in the initial access procedure and MIMO data transmission in the RRC connected mode. The limitations may also include an inability for early CSI acquisition. Specifically, an apparatus (e.g. UE) may not transmit a CSI report using a PUSCH scheduled by RAR UL grant in the non-contention-based random access procedure, because the apparatus lacks knowledge of whether a multi-port RS exists or how a multi-port RS is configured until RRC connection is established, or both.

Another drawback may include that the network device is unaware of quality of polarized sub-channels, isolation or interference between polarized sub-channels, or both, as is illustrated in FIG. 7. FIG. 7 illustrates a portion of a network 800 that includes a base station 805 and a UE 810. A single base station beam 807 and a single UE beam 812 that are only one beam of a number of beams that could be used at each device are shown as an example. These beams 807, 812 may be a beam pair that has been previously measured, reported, and/or selected as a preferred beam pair for communication between the devices at the time. The base station beam 807 and UE beam 812 are each shown to include two polarization directions, i.e. polarization directions associated with dual-polarized antennas, e.g. vertical polarization direction indicated by the “|” symbol above the beams and horizontal polarization direction indicated by the “−” symbol below the beams. The existing beam measurement and/or reporting mechanisms mix up the measurements over two polarization directions, e.g. from vertically polarized antennas at the base station 805 to vertically polarized antennas at the UE 810 (i.e. V2V) and from horizontally polarized antennas at the base station 805 to horizontally polarized antennas at the UE 810 (i.e. H2H). As a result, the base station deployed with dual-polarized antennas may have no knowledge about quality of polarized sub-channels, isolation or interference between polarized sub-channels (e.g. vertical polarization direction, horizontal polarization direction), or both, towards a particular UE, when using existing beam measurement and/or reporting mechanism.

The present disclosure provides systems and methods that may overcome some or all of the above drawbacks of existing communication systems and may enable single-user and multi-user MIMO transmission during or immediately after an initial access procedure. Some aspects of the present disclosure may reduce latency between SSB detection in the initial access procedure and MIMO data transmission. This may enable MIMO data transmission earlier than existing communication systems, thereby improving user experience and spectrum efficiency.

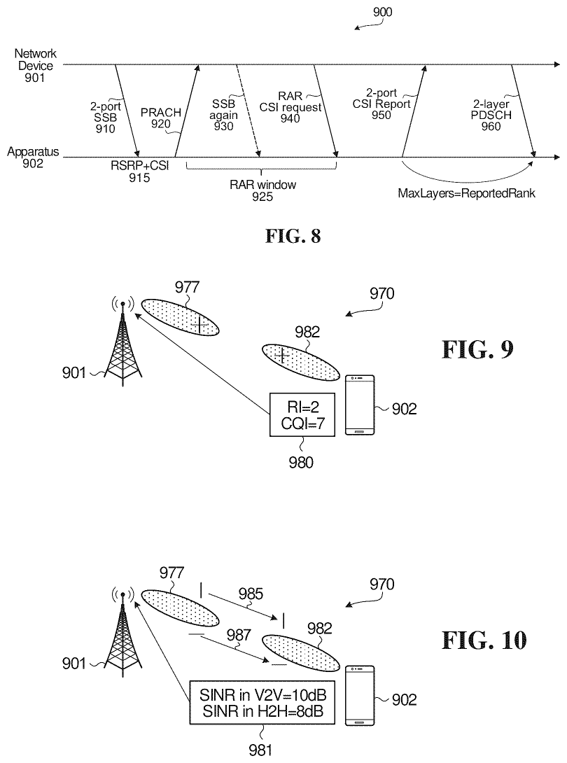

FIG. 8 illustrates an example of a signal flow diagram 900 for signaling that occurs between a network device 901 and an apparatus 902 that may reduce latency between SSB detection at the apparatus 902 and MIMO transmission by the network device 901 by using a CSI report transmitted over PUSCH or PUCCH, in accordance with embodiments of the present disclosure. For example, the CSI report may be transmitted using Message-3 (Msg3) PUSCH for contention-based random access. The CSI report is associated with one or more SSBs transmitted over 2 antenna ports because the CSI report is determined based on measurement of the SSBs.

In step 910, the network device 901 (e.g. base station) transmits on at least one beam, one or more 2-port SSBs using dual-polarized antennas of the network device 901. While FIG. 8 illustrates that the 2-port SSBs are transmitted from the network device 901 towards the apparatus 902 (e.g. UE), the network 901 may transmit the 2-port SSBs in a broadcast manner. In some embodiments, each antenna port of a 2-port SSB (e.g. each SSB port) of the network device 901 corresponds to antennas at the network device 901 over one polarization direction (e.g. vertical or horizontal polarization direction, −45 or +45 degree slant polarization direction).

At step 915, the apparatus 902 measures the reference signal received power (RSRP) of the SSB and may also generate a CSI report or determine the CSI based on measurement of the one or more SSBs transmitted over 2 antenna ports (e.g. 2-port SSBs) or the 2-port SSB associated with the PRACH transmission. The CSI report may be referred to as 2-port CSI report as the CSI report is based on measurement of the 2-port SSBs (i.e. SSBs transmitted over 2 antenna ports).

In some embodiments, the one or more SSBs transmitted over 2 antenna ports in step 910 include one or more signals, such as one or more primary synchronization signals (PSSs), one or more secondary synchronization signals (SSSs), a physical broadcast channel (PBCH), and/or one or more demodulation reference signals (DMRSs) for PBCH.

In some embodiments, the network device 901 transmits one or more signals indicative of system information. The one or more signals indicative of the system information may be transmitted in a master information block (MIB), a secondary information block (SIB), or both. The MIB or SIB may be included within or outside the one or more 2-port SSBs.

In step 920, the apparatus 902 transmits a random access preamble on a physical random access channel (PRACH) to the network device 901. The PRACH transmission of step 920 is associated with at least one SSB transmitted at step 910.

In some embodiments, the network device 901 may periodically transmit, on at least one beam, one or more 2-port SSBs using dual-polarized antennas of the network device 901. This periodic transmission of the one or more 2-port SSB(s) may occur, as shown in step 930, within a random access response (RAR) window 925 or within a time period between transmission of the PRACH and reception of a request for a CSI report that is transmitted by the network device 901 at step 940. In some embodiments, the at least one SSB transmitted at step 930 is associated with the PRACH transmission of step 920. In some embodiments, as the periodic transmission of the one or more 2-port SSBs may or may not occur within the RAR window 925, the step 930 is described using a dashed arrow in FIG. 8. If the one or more 2-port SSBs is transmitted within the RAR window 925, the CSI report may be determined based on measurement of the one or more SSBs transmitted in step 930. If no 2-port SSB is transmitted within the RAR window 925, then the CSI report may be determined based on measurement of the one or more SSBs transmitted in step 910. As discussed in further detail below, the periodic transmission of the one or more 2-port SSBs within the RAR window or the time period may be particularly useful when the apparatus is in motion and therefore provide an updated and more relevant SSB measurement as compared to the initial SSB measurement at step 910.

In step 940, the network device 901 transmits a request to the apparatus 902 for a CSI report. In some embodiments, the request for a CSI report may be transmitted on a RAR in response to the PRACH transmission in step 920.

Upon receiving the request for a CSI report, the apparatus 902, in step 950, transmits a response to the CSI report request. In some embodiments, the response may be transmitted using PUSCH during random access (RA) procedure, for example using Msg3 PUSCH. In some embodiments, the response may be transmitted on a PUCCH. The response may include at least one of an indication of whether a CSI report is included in the response, or the CSI report. As stated above, the CSI report may be determined based on measurement of the one or more SSBs transmitted over 2 antenna ports (i.e. one or more 2-port SSBs) at step 910 or 930. The CSI report may be determined based on measurement of the most recently received one or more SSBs or most recent measurement of the SSB associated with the PRACH transmission that is at least X symbols or slots earlier than the symbol or slot in which the PUSCH or PUCCH carrying the CSI report is transmitted, where X is a positive integer.

In some embodiments, when the one or more 2-port SSBs are transmitted at step 930, which is within a RAR window 925 or within a time period between transmission of the PRACH (at step 920) and reception of a request for a CSI report (at step 940), the apparatus 902 may determine the CSI report based on measurement of the most recently received one or more 2-port SSBs or most recent measurement of the SSB associated with the PRACH transmission. These SSBs are more recent and thereby up-to-date as compared to those transmitted at step 910. In this way, the CSI report to be reported at step 950 may remain up-to-date, when a RAR including a CSI request is transmitted to the apparatus 902.

In step 960, after the network device 901 receives the CSI report, the network device 901 enables multi-layer transmission to the apparatus 902. The CSI report received by the network device 901 may include information related to apparatus-specific CSI or information indicative of quality of sub-channels, or both. In some embodiments, the information related to apparatus-specific CSI may include at least one of a rank indicator (RI), a channel quality indicator (CQI), or a precoding matrix indicator (PMI), which are used mainly for single-user MIMO transmissions for the specific apparatus. In some embodiments of the signal flow diagram 900, the specific apparatus may be the apparatus 902. The information indicative of quality of sub-channels may include per-SSB-port signal-to-interference plus noise ratio (SINR), per-SSB-port CQI, per-PMI SINR, or per-PMI CQI. The per-SSB-port SINR, per-SSB-port CQI, per-PMI SINR or per-PMI CQI may reflect quality of sub-channels or isolation between sub-channels (e.g. sub-channels over vertical polarization direction and horizontal polarization direction), or both, to enable intra-apparatus multiplexing or inter-apparatus multiplexing, or both, of same or different signals/channels. The sub-channels may be measured at the apparatus 902 to determine the quality of sub-channels or isolation between sub-channels. In some cases, the apparatus 902 may be a UE. In some cases, the information indicative of quality of sub-channels may also be considered as one type or part of CSI.

FIG. 9 illustrates an example of contents of a CSI report 980 being transmitted via PUCCH or PUSCH, the CSI report including at least one of a rank indicator (RI) or a channel quality indicator (CQI), in accordance with embodiments of the present disclosure. FIG. 9 illustrates a portion of a network 970 that includes a network device 901 (e.g. base station) and an apparatus 902 (e.g. UE). A single network device beam 977 and a single apparatus beam 982, each of which has two polarization directions (horizontal polarization direction “−” and vertical polarization direction “|”) indicated by the “+” symbol, are shown as an example. In FIG. 9, CSI report 980 is shown to include RI, RI=2, and CQI, CQI=7. While CSI report 980 is shown to include RI and CQI, it should be understood that this is merely by way of example and the CSI report 980 may include one or more of SSB resource indicator (SSBRI), RSRP, SINR, RI, CQI, precoding matrix indicator (PMI), per-SSB-port SINR, per-SSB-port CQI, per-PMI SINR or per-PMI CQI. In some embodiments where the CSI report includes a RI indicating a maximum rank, after transmission of the CSI report, the apparatus 902 may behave based on the assumption that the maximum number of layers for physical downlink share channel (PDSCH) is equal to the value of reported rank indicator (i.e. reported maximum rank) or the smallest integer 2n that is less than or equal to the reported maximum rank (n=0, 1, 2, 3, . . . ). Based on this assumption, the apparatus 902 may not wait for explicit configuration of maximum MIMO layers for PDSCH from the network device. For example, if the rank indicator included in the CSI report is greater than 1, e.g., RI=4, the apparatus 902 may assume a multi-layer physical downlink shared channel (PDSCH) reception with up to 4 layers without receiving an explicit configuration for receiving multi-layer PDSCH from the network device 901.

In some embodiments, the CSI report may alternatively, or additionally, include per-SSB-port SINR or CQI, per-PMI SINR or CQI, or some combination thereof. In some embodiments, each SINR or CQI is associated with a respective SSB port or a respective PMI, or both. The per-SSB-port SINR or per-SSB-port CQI may indicate one or more of quality of sub-channels, isolation on parallel sub-channels, or interference on parallel sub-channels. When deriving the SINR or CSI for one (particular) SSB port, one or more other SSB ports of the same SSB may be considered as interference. In this way, the isolation or interference on parallel sub-channels over dual polarization directions are reflected in the reported per-SSB-port SINRs or per-SSB-port CQIs. The per-PMI SINR or per-PMI CQI may indicate one or more of quality of sub-channels, isolation on parallel sub-channels or interference on parallel sub-channels.

FIG. 10 illustrates another example of contents of a CSI report 981 being determined and sent from the apparatus 902 (e.g. UE) to the network device 901 (e.g. base station) in accordance with embodiments of the present disclosure. The CSI report 981 of FIG. 10 is transmitted over PUCCH or PUSCH and is shown to include per-SSB-port SINR indicating quality of sub-channel from vertically polarized antennas at the network device 901 to vertically polarized antennas at the apparatus 902 (i.e. SINR in V2V) and per-SSB-port SINR indicating quality of sub-channel from horizontally polarized antennas at the network device 901 to horizontally polarized antennas at the apparatus 902 (i.e. SINR in H2H). In some embodiments, the CSI report is transmitted over PUCCH or PUSCH and includes per-SSB-port CQI, such as CQI in V2V and CQI in H2H. To account for possible movement and/or rotation of the network device 901 and/or the apparatus 902, in some embodiments, the CSI report may include SINR or CQI for each SSB port (per-SSB-port SINR or per-SSB-port CQI) or SINR or CQI for each reported PMI (per-PMI SINR or per-PMI CQI). In such cases, how each SSB port is transmitted by the network device 901 (e.g. via polarized antennas over one polarization direction, transmit precoding with multiple antennas) and how each SSB port is received by the apparatus 902 (e.g. via polarized antennas over one polarization direction, receive precoding with multiple antennas) is left to the choice of the network device 901 and the apparatus 902, respectively.

Each SINR or CQI is associated with a respective SSB port. Each SSB port may be transmitted via antennas of the network device 901 over one polarization direction. For example, each SSB port may be transmitted from antennas of the network device 901 over a vertical polarization direction or a horizontal polarization direction. The per-SSB-port SINR or per-SSB-port CQI may reflect the reception quality of sub-channel over one polarization direction.

To enable concurrent transmission over parallel sub-channels over dual polarization directions, each per-SSB-port SINR or per-SSB-port CQI value may be determined based on a particular SSB port and one or more other SSB ports of the same SSB. When determining the SINR or CQI for a particular SSB port, the one or more other SSB ports of the same SSB may be considered as interference. In this way, the determined SINR or CQI included in the CSI report may reflect isolation or interference between sub-channels over dual polarization directions. In some embodiments, the per-SSB-port SINR or per-SSB-port CQI may also facilitate the network device to schedule intra-apparatus spatial multiplexing of signals or channels or polarization domain multiplexing of signals or channels, or both. In some embodiments, the per-SSB-port SINR or per-SSB-port CQI may also facilitate the network device to schedule inter-apparatus spatial multiplexing of signals or channels or polarization domain multiplexing of signals and/or channels, or both. The network device may schedule a multiplexing of the same or different signals or channels, or both.

In some embodiments, the CSI report includes the per-PMI SINR or per-PMI CQI. Each SINR or CQI is associated with a respective PMI. When determining the SINR or CQI for a particular PMI, one or more other PMIs may be considered as interference for the particular PMI. In some embodiments, the per-PMI SINR or per-PMI CQI may also facilitate the network device to schedule intra-apparatus multiplexing of signals or channels, or both. The network device may schedule a multiplexing of the same or different signals or channels, or both.

According to some embodiments, a signaling method is provided for enabling transmission of the CSI report associated with one or more SSBs transmitted over 2 antenna ports (i.e. one or more 2-port SSBs). In some embodiments, the CSI report may be transmitted on a PUSCH (e.g. Msg3 PUSCH) or a PUCCH.

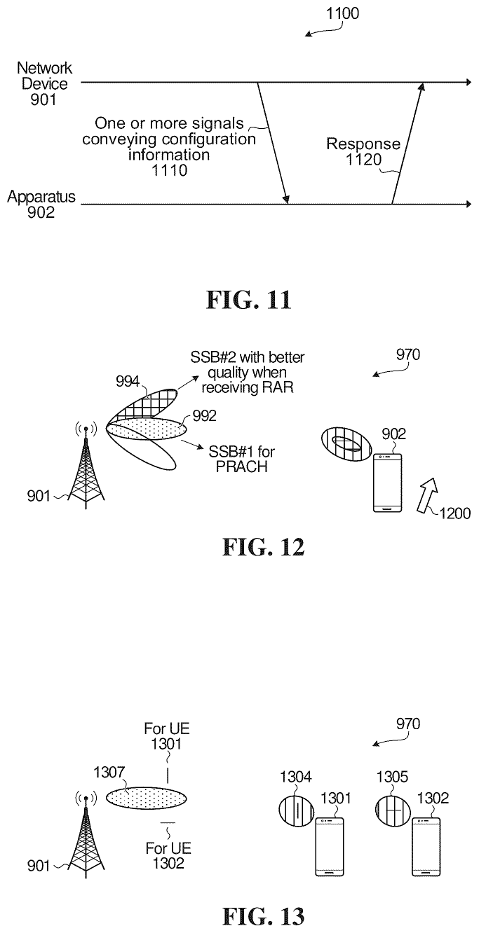

FIG. 11 illustrates an example of a signal flow diagram for transmission of configuration information related to the CSI report and/or demodulation reference signal (DMRS), in accordance with embodiments of the present disclosure.

At step 1110, the network device 901 (e.g. base station) may transmit to an apparatus 902 (e.g. UE) one or more signals to convey configuration information that may be used by the apparatus 902 to determine whether and how to generate or transmit a CSI report based on one or more 2-port SSBs, or both. While FIG. 11 illustrates that the configuration information is transmitted from the network device 901 to the apparatus 902 (e.g. UE), the network device 901 may transmit the configuration information in a broadcast manner. In some embodiments, the configuration information transmitted in step 1110 may be included as a part of the signaling transmitted in step 910 of FIG. 8, for example in MIB carried over PBCH. In some embodiments, the configuration information transmitted in step 1110 may be a separate signaling step, either before or after the signaling transmitted in step 910 of FIG. 8.

In some embodiments, the configuration information may be in the form of system information. The configuration information may be transmitted in a MIB or a SIB, or both. In such a case, the configuration information may be transmitted by the network device 901 within or after or together with the one or more 2-port SSBs. Put another way, in some embodiments, the network device 901, at step 1110, may broadcast configuration information within or after or together with the one or more 2-port SSBs. In some embodiments where the configuration information is in the form of system information, if the configuration information is included in a MIB, the configuration is carried over PBCH which may be included within the one or more 2-port SSBs. If the configuration information is included in a SIB, the configuration information is carried over PDSCH. The configuration information may be transmitted after the one or more 2-port SSBs (e.g. received by a UE in a slot later than the slot for the 2-port SSBs) or together with the one or more 2-port SSBs.

The information conveyed by the configuration information may include one or more of configuration information related to measurement configuration information or report format configuration for the CSI report based on one or more 2-port SSBs (i.e., based on one or more SSBs transmitted over 2 antenna ports of the network device 901), configuration information indicative of whether a CSI report is to be transmitted via PUSCH, such as Msg-3 PUSCH, configuration information indicative of whether a CSI report is to be transmitted via PUCCH, or information related to demodulation reference signal (DMRS) configuration for supporting multi-layer PDSCH transmission after transmitting the CSI report.

Configuration information related to measurement configuration information may for example be related to informing the apparatus 902 the reference signal (e.g., SSS, PBCH-DMRS, additional CSI-RS, additional CSI-RS for tracking) that is to be measured in step 910 or 915 in FIG. 8 or what type of measurement (e.g. RSRP, SINR, RI, CQI, PMI, per-SSB-port SINR, per-SSB-port CQI, per-PMI SINT, per-PMI CQI) the apparatus 902 may perform at step 915 in FIG. 8. Report format configuration information may for example be related to informing the apparatus 902 the type of report information (e.g. RSRP, SINR, RI, CQI, PMI, per-SSB-port SINR, per-SSB-port CQI, per-PMI SINT, per-PMI CQI) the apparatus 902 is to transmit back to the network device 901 in step 950 in FIG. 8.

In some embodiments, each of the identified types of configuration information may be included in one respective signal. In some embodiments, several of the identified types of configured information may be included in one signal.

In some embodiments, the network device 901 may transmit, at step 1110, one or more signals including configuration information related to at least one of measurement configuration information or report format configuration information for the CSI report based on one or more 2-port SSBs (i.e., based on one or more SSBs transmitted over 2 antenna ports of the network device 901). The configuration information related to the at least one of measurement configuration information or report format configuration information for the CSI report based on one or more 2-port SSBs includes at least one of information indicative of whether SSB resource indicator (SSBRIs) is to be reported; information indicative of the number of SSBRIs to be reported; information indicative of which one or more parameters among SSBRI, RSRP, SINR, RI, CQI, PMI, per-SSB-port SINR, per-SSB-port CQI, per-PMI SINR or per-PMI CQI are to be reported; or information indicative of whether the CSI report is restricted to the SSB that is associated with the PRACH transmission.

Still referring to FIG. 11, after receiving one or more signals conveying configuration information related to the CSI report and/or DMRS, the apparatus 902, at step 1120, may transmits a response, for example to the network device 901. The response may include an indication of whether a CSI report is included in the response, the CSI report, or both. The CSI report may be based on measurement of the one or more SSBs transmitted over the 2 antenna ports of the network device 901 (i.e. one or more 2-port SSBs transmitted from the network device 901). If the response includes the CSI report, the CSI report may be transmitted in a manner described above with respect to step 950 of FIG. 8. Therefore, in some embodiments, the step 1120 may correspond to step 950 of FIG. 8 or include information that is part of signaling transmitted in step 950 of FIG. 8.

In some embodiments, a network device transmits (e.g. broadcasts) a signal including configuration information indicative of whether an apparatus is expected to determine or measure CSI (e.g. information to be included in a CSI report) based on one or more 2-port SSBs. The information to be included in the CSI report includes at least one of SSBRI, RSRP, SINR, RI, CQI, PMI, per-SSB-port SINR, per-SSB-port CQI, per-PMI SINR or per-PMI CQI. It should be noted that each SINR or CQI is associated with a respective SSB port or a respective PMI, or both. In some embodiments, signaling that includes information indicative of whether an apparatus is expected to determine or measure CSI based on one or more 2-port SSBs, may allow the network device to enable or disable this CSI determination or measurement activity at potential apparatuses, e.g. to disable this activity when there is no urgent need for MIMO data transmissions. This may allow the associated network device or the apparatus, or both to save energy.

In some embodiments, the network device transmits (e.g. broadcasts) a signal including configuration information indicative of whether or not the measurement resource is restricted to the SSB associated with the PRACH transmission. Based on this indication, the apparatus may report CSI for one or more SSBs that are different from the SSB associated with the PRACH transmission. Because of this indication, the apparatus does not have to be restricted to report CSI for the SSB associated with the PRACH transmission but may report CSI for other recently received SSBs with better reception quality. In some embodiments, an SSBRI may be reported via PUSCH, such as a Msg3 PUSCH. In some embodiments, the information indicative of whether the measurement resource is restricted to the SSB associated with the PRACH transmission may be transmitted in a MIB or a SIB, or both. In this way, the apparatus may be enabled to report CSI for an SSB or a network device beam that is different from the SSB or the network device beam associated with the PRACH transmission, such as when there is cross-SSB or cross-beam movement of the apparatus during initial access process, as illustrated in FIG. 12.

FIG. 12 illustrates an example of determining a CSI report based on an SSB that is different from the SSB associated with the PRACH transmission, in accordance with embodiments of the present disclosure. FIG. 12 illustrates a portion of the network 970 that includes the network device 901 and the apparatus 902. In FIG. 12, SSB #1 and SSB #2 are periodically transmitted in different beam directions, i.e. beam 992 and beam 994. At a first time instance, the apparatus 902 measures and selects SSB #1 for PRACH transmission, i.e., the apparatus 902 selects the PRACH resource or occasion or sequence associated with SSB #1, where SSB #1 is the SSB associated with the PRACH transmission. As the apparatus 902 moves in a direction indicated by the arrow 1200, at a second time instance, e.g. in a time period between the transmission of the PRACH and the reception of the request for the CSI report, measurement of SSB #2 may have better quality than SSB #1 associated with the PRACH transmission. Thus, the CSI report may be determined based on the measurement of the SSB #2.

In some embodiments, the network device transmits (e.g. broadcasts) a signal including configuration information related to report format configuration information for the CSI report based on the one or more 2-port SSBs to be transmitted from the apparatus to the network device over PUSCH or PUCCH. The network device may indicate report format configuration information of the CSI report based on one or more of SSBRI, RSRP, SINR, RI, CQI, PMI, per-SSB-port SINR, per-SSB-port CQI, per-PMI SINR, or per-PMI CQI. For instance, the network device may indicate the parameter to be reported in the CSI report in terms of parameters to be reported such as SSBRI, RSRP, SINR, RI, CQI, PMI, per-SSB-port SINR, per-SSB-port CQI, per-PMI SINR, or per-PMI CQI so that the apparatus may know what information to include in the CSI report. This information may also allow the network device to select a desired operating mode. Examples of operating modes include apparatus-specific throughput maximization mode, intra-apparatus polarization domain multiplexing mode, intra-apparatus PMI-based multiplexing mode, inter-apparatus polarization-based multiplexing mode (even with same beam transmitted from the network device). The report format configuration information for the CSI report based on the one or more 2-port SSBs may be transmitted in a MIB or a SIB, or both.

FIG. 13 illustrates an example of inter-apparatus polarization-based multiplexing using the same beam transmitted from a network device, in accordance with embodiments of the present disclosure. FIG. 13 illustrates a portion of a network 970 that includes the base station 901, a first UE 1301 and a second UE 1302. A single base station beam 1307 is shown. The base station beam 1307 is shown to include two polarization directions, i.e. a vertical polarization direction indicated by the “|” symbol above the beam and a horizontal polarization direction indicated by the “−” symbol below the beam. Signals transmitted on the vertical polarization direction by the base station 901 are detected and received by a beam 1304 over a vertical polarization direction at the first UE 1301, and signals transmitted on the horizontal polarization direction by the base station 901 are detected and received by a beam 1305 over a horizontal polarization direction at the second UE 1302.

As stated above, upon receiving the request for a CSI report, the apparatus transmits a response to the request for a CSI report. In some embodiments, the apparatus includes, in the response, an indication of whether a CSI report is included in the response. Provided that the response may be transmitted on a PUSCH or a PUCCH, this indication may provide an indication on whether a CSI report exists in the message carried in the PUSCH or the PUCCH. The indication of whether the CSI report is included in the response to the request for a CSI report may be needed because the apparatus may choose not to generate a CSI report for power saving purposes. For example, while the network device transmits over broadcast signaling such as MIB or SIB, or both indicating that a CSI report is to be transmitted via PUSCH, for example in a Msg3, the apparatus may choose not to generate the CSI report to save energy at the apparatus. When the apparatus chooses not to generate the CSI report, the apparatus may include an indication that a CSI report is not included in the response (e.g. response to the CSI report request) so that the network device does not need to search for a CSI report in the response received from the apparatus. When a CSI report is included in the response, the apparatus may include an indication that a CSI report is included in the response to the request for a CSI report. In this way, blind detection complexity may be reduced at the network device.

In some embodiments, the network device may transmit (e.g. broadcasts) one or more signals to convey information related to DMRS configuration information supporting multi-layer (or multi-port) PDSCH transmission. In order to enable MIMO transmission or multi-layer PDSCH transmission (e.g. 2-layer transmission) immediately after transmission of a CSI report over the PUSCH (e.g. Msg3 PUSCH) or PUCCH, the apparatus may be provided with DMRS configuration information that supports multi-layer PDSCH transmission. Such DMRS configuration information may be provided to the apparatus before enabling the MIMO transmission or multi-layer PDSCH transmission. In some embodiments, the DMRS configuration information supporting multi-layer PDSCH transmission may be pre-defined or be signaled by the network device using MIB, SIB, or RAR. In some embodiments where the DMRS configuration information supporting multi-layer PDSCH transmission is signaled using MIB, SIB or RAR, the apparatus may determine the existence or bit length of an indication of antenna ports in a DCI format that the apparatus may detect, based on the received DMRS configuration information.

While one or more steps of the methods described above are based on dual-polarized antennas with vertical or horizontal polarization directions, or both, it should be understood that the methods may be performed using dual-polarized antennas with ±45 degree slant polarization directions. Similarly, while one or more steps of the methods described above are based on dual-polarized antennas with about 90 degree difference in polarization direction (i.e. vertical/horizontal polarization directions, ±45 degree slant polarization directions), it should be understood that the methods may be performed using dual-polarized antennas with a non −90 difference (e.g. 60 degree) in a polarization direction. Furthermore, while one or more steps of the methods described above are based on dual-polarized antennas with two polarization directions, it should be understood that the methods may be performed using antenna structures or architectures that may be considered such that the network device or the apparatus is equipped with antennas capable of transmitting or receiving over M polarization directions, where M is an integer greater than 2. In this case, the 2-port SSB mentioned in embodiments or examples illustrated above or elsewhere in the present disclosure may be replaced as M-port SSB.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method by an apparatus, comprising:
receiving a request for a channel state information (CSI) report associated with one or more synchronization signal-physical broadcast channel (SS-PBCH) blocks (SSBs), wherein the one or more SSBs are transmitted over two antenna ports; and
transmitting a response to the request for the CSI report on a physical uplink shared channel (PUSCH) or a physical uplink control channel (PUCCH), the response including at least one of:
an indication of whether the CSI report is included in the response; or
the CSI report based on measurement of the one or more SSBs transmitted over the two antenna ports.

2. The method of claim 1, wherein the CSI report includes at least one of:
an SSB resource indicator (SSBRI);
a reference signal received power (RSRP);
a signal-to-interference plus noise ratio (SINR);
a rank indicator (RI);
a channel quality indicator (CQI);
a precoding matrix indicator (PMI);
at least one per-SSB-port SINR or at least one per-SSB-port CQI, wherein each per-SSB-port SINR of the at least one per-SSB-port SINR or each per-SSB-port CQI of the at least one per-SSB-port CQI is associated with a respective SSB port; or
at least one per-PMI SINR or per-PMI CQI, wherein each per-PMI SINR of the at least one per-PMI SINR or each per-PMI CQI of the at least one per-PMI CQI is associated with a respective PMI.

3. The method of claim 2, wherein, for each per-SSB-port SINR or each per-SSB-port CQI, a respective per-SSB-port SINR or a respective per-SSB-port CQI is determined based on the respective SSB port and one or more remaining SSB ports of the respective SSB, where the one or more remaining SSB ports are considered as interference during determination of the respective per-SSB-port SINR or the respective per-SSB-port CQI.

4. The method of claim 1, further comprising:
receiving one or more signals indicative of system information in at least one of a master information block (MIB) or a secondary information block (SIB).

5. The method of claim 4, wherein the one or more signals include one or more of:
information related to at least one of measurement configuration or report configuration for the CSI report based on the one or more SSBs transmitted over the two antenna ports;
information indicative of whether the CSI report is to be transmitted via a Message-3 in the PUSCH;
information indicative of whether the CSI report is to be transmitted via the PUCCH; or
information related to demodulation reference signal (DMRS) configuration supporting multi-layer PDSCH transmission after transmitting the CSI report.

6. The method of claim 5, wherein the information related to the at least one of the measurement configuration or the report configuration for the CSI report includes at least one of:
information indicative of whether one or more SSBRIs are to be reported;
information indicative of a number of the one or more SSBRIs to be reported;
information indicative of which one or more parameters among an SSBRI, an RSRP, an SINR, an RI, a CQI, a PMI, at least one per-SSB-port SINR or at least one per-SSB-port CQI, at least one per-PMI SINR or at least one per-PMI CQI are to be reported; or
information indicative of whether the CSI report is restricted to an SSB associated with physical random access channel (PRACH) transmission.

7. The method of claim 1, wherein the one or more SSBs transmitted over the two antenna ports comprise one or more of:
one or more primary synchronization signals (PSSs);
one or more secondary synchronization signals (SSSs);
a physical broadcast channel (PBCH); or
one or more DMRSs for the PBCH.

8. An apparatus, comprising:
one or more processors, when executing program instructions stored in the apparatus, cause the apparatus to:
receive a request for a channel state information (CSI) report associated with one or more synchronization signal-physical broadcast channel (SS-PBCH) blocks (SSBs), wherein the one or more SSBs are transmitted over two antenna ports; and
transmit a response to the request for the CSI report on a physical uplink shared channel (PUSCH) or a physical uplink control channel (PUCCH), the response including at least one of:
an indication of whether the CSI report is included in the response; or
the CSI report based on measurement of the one or more SSBs transmitted over the two antenna ports.

9. The apparatus of claim 8, wherein the CSI report includes at least one of:
an SSB resource indicator (SSBRI);
a reference signal received power (RSRP);
a signal-to-interference plus noise ratio (SINR);
a rank indicator (RI);
a channel quality indicator (CQI);
a precoding matrix indicator (PMI);
at least one per-SSB-port SINR or at least one per-SSB-port CQI, wherein each per-SSB-port SINR of the at least one per-SSB-port SINR or each per-SSB-port CQI of the at least one per-SSB-port CQI is associated with a respective SSB port; or
at least one per-PMI SINR or at least one per-PMI CQI, wherein each per-PMI SINR of the at least one per-PMI SINR or each per-PMI CQI of the at least one per-PMI CQI is associated with a respective PMI.

10. The apparatus of claim 9, wherein, for each per-SSB-port SINR or each per-SSB-port CQI, a respective per-SSB-port SINR or a respective per-SSB-port CQI is determined based on the respective SSB port and one or more remaining SSB ports of the respective SSB, where the one or more remaining SSB ports are considered as interference during determination of the respective per-SSB-port SINR or the respective per-SSB-port CQI.

11. A method, comprising:
transmitting a request for a channel state information (CSI) report associated with one or more synchronization signal-physical broadcast channel (SS-PBCH) blocks (SSBs), wherein the one or more SSBs are transmitted over two antenna ports; and
receiving a response to the request for the CSI report on a physical uplink shared channel (PUSCH) or a physical uplink control channel (PUCCH), the response including at least one of:
an indication of whether the CSI report is included in the response; or
the CSI report based on measurement of the one or more SSBs transmitted over the two antenna ports.

12. The method of claim 11, wherein the CSI report includes at least one of:
an SSB resource indicator (SSBRI);
a reference signal received power (RSRP);
a signal-to-interference plus noise ratio (SINR);
a rank indicator (RI);
a channel quality indicator (CQI);
a precoding matrix indicator (PMI);
at least one per-SSB-port SINR or at least one per-SSB-port CQI, wherein each per-SSB-port SINR of the at least one per-SSB-port SINR or each per-SSB-port CQI of the at least one per-SSB-port CQI is associated with a respective SSB port; or
at least one per-PMI SINR or at least one per-PMI CQI, wherein each per-PMI SINR of the at least one per-PMI SINR or each per-PMI CQI of the at least one per-PMI CQI is associated with a respective PMI.

13. The method of claim 12, wherein, for each per-SSB-port SINR or each per-SSB-port CQI, a respective per-SSB-port SINR or a respective per-SSB-port CQI is determined based on the respective SSB port and one or more remaining SSB ports of the respective SSB, where the one or more remaining SSB ports are considered as interference during determination of the respective per-SSB-port SINR or the respective per-SSB-port CQI.

14. The method of claim 11, further comprising:
transmitting one or more signals indicative of system information in at least one of a master information block (MIB) or a secondary information block (SIB).

15. The method of claim 14, wherein the one or more signals include one or more of:
information related to at least one of measurement configuration or report configuration for the CSI report based on the one or more SSBs transmitted over the two antenna ports;
information indicative of whether the CSI report is to be transmitted via a Message-3 in the PUSCH;
information indicative of whether the CSI report is to be transmitted via the PUCCH; or
information related to demodulation reference signal (DMRS) configuration supporting multi-layer PDSCH transmission after transmitting the CSI report.

16. The method of claim 15, wherein the information related to the at least one of the measurement configuration or the report configuration for the CSI report includes at least one of:
information indicative of whether one or more SSBRIs are to be reported;
information indicative of a number of the one or more SSBRIs to be reported;
information indicative of which one or more parameters among an SSBRI, an RSRP, an SINR, an RI, a CQI, a PMI, at least one per-SSB-port SINR or at least one per-SSB-port CQI, at least one per-PMI SINR or per-PMI CQI are to be reported; or
information indicative of whether the CSI report is restricted to an SSB associated with physical random access channel (PRACH) transmission.

17. The method of claim 11, wherein the one or more SSBs transmitted over the two antenna ports comprise one or more of:
one or more primary synchronization signals (PSSs);
one or more secondary synchronization signals (SSSs);
a physical broadcast channel (PBCH); or
one or more DMRSs for the PBCH.

18. An apparatus, comprising:
one or more processors, when executing program instructions stored in the apparatus, cause the apparatus to:
transmit a request for a channel state information (CSI) report associated with one or more synchronization signal-physical broadcast channel (SS-PBCH) blocks (SSBs), wherein the one or more SSBs are transmitted over two antenna ports; and
receive a response to the request for the CSI report on a physical uplink shared channel (PUSCH) or a physical uplink control channel (PUCCH), the response including at least one of:
an indication of whether the CSI report is included in the response; or
the CSI report based on measurement of the one or more SSBs transmitted over the two antenna ports.

19. The apparatus of claim 18, wherein the CSI report includes at least one of:
an SSB resource indicator (SSBRI);
a reference signal received power (RSRP);
a signal-to-interference plus noise ratio (SINR);
a rank indicator (RI);
a channel quality indicator (CQI);
a precoding matrix indicator (PMI);
at least one per-SSB-port SINR or at least one per-SSB-port CQI, wherein each per-SSB-port SINR of the at least one per-SSB-port SINR or each per-SSB-port CQI of the at least one per-SSB-port CQI is associated with a respective SSB port; or
at least one per-PMI SINR or at least one per-PMI CQI, wherein each per-PMI SINR of the at least one per-PMI SINR or each per-PMI CQI of the at least one per-PMI CQI is associated with a respective PMI.

20. The apparatus of claim 19, wherein, for each per-SSB-port SINR or each per-SSB-port CQI, a respective per-SSB-port SINR or a respective per-SSB-port CQI is determined based on the respective SSB port and one or more remaining SSB ports of the respective SSB, where the one or more remaining SSB ports are considered as interference during determination of the respective per-SSB-port SINR or the respective per-SSB-port CQI.
